(19) United States
(12) Patent Application Publication
(10) Pub. No.: US 2012/0227774 A1
(43) Pub. Date: Sep. 13, 2012

(54) RINSING MACHINE FOR CONTAINERS, IN PARTICULAR BOTTLES

(75) Inventor: Gianluca Pongolini, Parma (IT)

(73) Assignee: Sidel S.p.A. con Socio Unico, Parma (IT)

(21) Appl. No.: 13/393,965

(22) PCT Filed: Sep. 2, 2009
(86) PCT No.: PCT/IT09/00395

§ 371 Date: May 18, 2012

(51) Int. Cl. B08B 9/28; B08B 5/00; B08B 9/093; B08B 3/02

(52) U.S. Cl. 134/57 R; 134/102.1

(57) ABSTRACT

A rotary rinsing machine has at least one rinsing unit for rinsing a respective container with a wash mixture fed to the rinsing unit by a first conduit, which is connected to a first header containing a liquid fluid, and is connected to a second conduit for feeding a gaseous fluid from a second header to the first conduit; at least one measuring device being provided to measure the pressure in the first header and/or in the second header and/or in the first conduit and/or in the second conduit.

### TECHNICAL FIELD

The present invention relates to a rinsing machine for containers, in particular bottles.

### BACKGROUND ART

In the bottling industry, a rotary rinsing machine is known comprising a wash wheel mounted to rotate about a given longitudinal axis and having a number of rinsing units, which are equally spaced about the axis, are fed about the axis by the wash wheel, have respective grip-and-carry devices, each for receiving and retaining a respective container, and have respective spray nozzles, each for washing a respective container before it is filled.

The containers are washed with a gaseous fluid and liquid fluid mixture, which is fed to the spray nozzles by a feed device comprising a first header for the liquid fluid, a second header for the gaseous fluid, and, for each rinsing unit, a respective first conduit for feeding the liquid fluid from the first header to the relative spray nozzle, and a respective second conduit for feeding the gaseous fluid from the second header to the first conduit.

Though widely used, known rinsing machines of the above type have several drawbacks, mainly due to their being unable to check correct operation of the rinsing units, and to reject any improperly rinsed containers.

### DISCLOSURE OF INVENTION

It is an object of the present invention to provide a rinsing machine for containers, in particular bottles, designed to eliminate the above drawbacks, and which is cheap end easy to implement.

According to the present invention, there is provided a rinsing machine for containers, in particular bottles, as claimed in the accompanying Claims.

### BRIEF DESCRIPTION OF THE DRAWINGS

A non-limiting embodiment of the present invention will be described by way of example with reference to the accompanying drawings, in which:

FIG. 1 shows a schematic view in perspective, with parts removed for clarity, of a preferred embodiment of the rinsing machine according to the present invention;

FIG. 2 shows a schematic view in perspective, with parts removed for clarity, of a detail in FIG. 1;

FIG. 3 shows a schematic view in perspective, with parts removed for clarity, of a detail in FIG. 2.

### BEST MODE FOR CARRYING OUT THE INVENTION

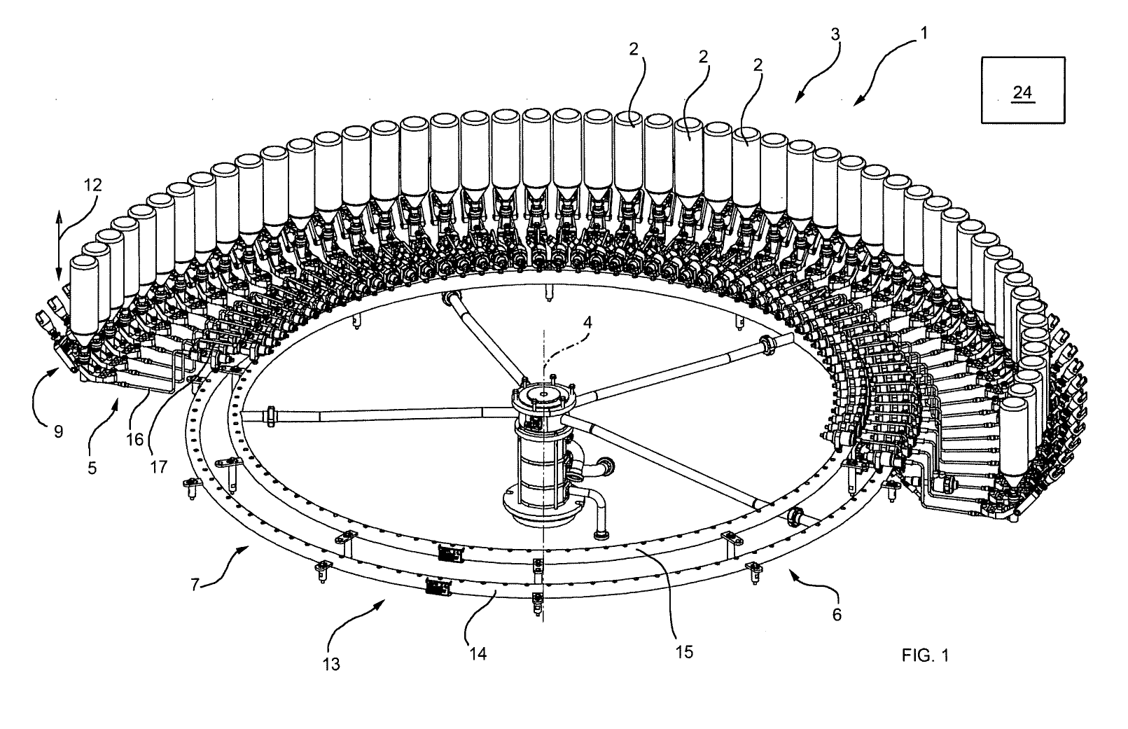

Number 1 in FIG. 1 indicates as a whole a rotary rinsing machine for rinsing containers defined, in the example shown, by glass or PET bottles 2.

Machine 1 comprises a wash wheel 3 mounted to rotate about a substantially vertical longitudinal axis 4, and having a number of rising units 5, which are equally spaced about axis 4, are fitted along a peripheral edge of wheel 3, and are fed by wheel 3 about axis 4 and through an input station 6, where bottles 2 are fed onto machine 1, and an output station 7, where bottles 2 are fed off machine 1.

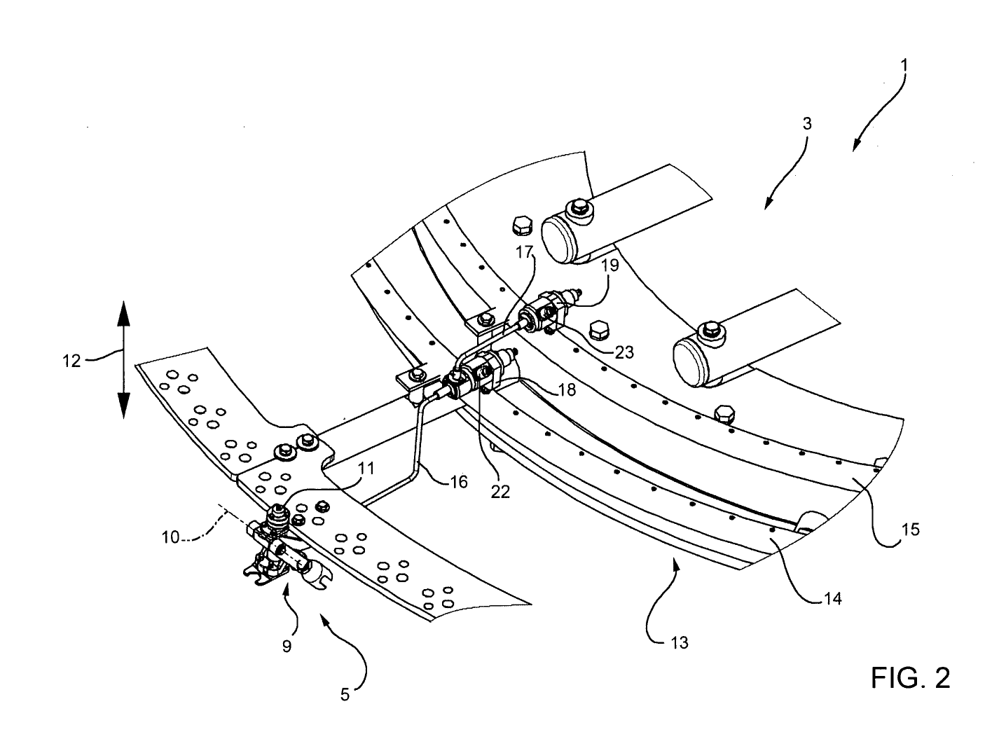

As shown in FIGS. 1, 2 and 3, each unit 5 comprises a mounting block 8 fixed to wheel 3; a grip-and-carry device 9 for gripping and carrying a respective bottle 2, and which is fitted in rotary manner to block 8 to rotate, with respect to block 8 and under the control of a known actuating device not shown, about a substantially horizontal hinge axis 10 crosswise to axis 4; and a spray nozzle 11 fitted in sliding manner to block 8 to perform straight movements, with respect to block 8, in a vertical direction 12 parallel to axis 4.

Each bottle 2 is washed with a pressurized washing mixture comprising a liquid fluid—water in the example shown—and a gaseous fluid—air in the example shown, and which is fed to units 5, and therefore to nozzles 11, by a feed device 13.

Device 13 comprises a first annular header or manifold 14, which extends about axis 4, is fed about axis 4 by wheel 3, and is supplied with pressurized water; a second annular header or manifold 15, which is mounted inwards of header 14 and coaxially with axis 4, is fed by wheel 3 about axis 4, and is supplied with pressurized air; and, for each unit 5, a respective first conduit 16 connecting header 14 to relative nozzle 11, and a respective second conduit for feeding pressurized air from header 15 to conduit 16.

Each conduit 16, 17 is opened selectively by a respective known on-off valve 18, 19 fitted along conduit 16, 17.

The pressure in header 14 is monitored by a measuring device defined, in the example shown, by a known pressure transducer 20 inserted inside header 14; the pressure in header 15 is monitored by a measuring device defined, in the example shown, by a known pressure transducer 21 inserted inside header 15; the pressure in each conduit 16 is monitored by a respective measuring device defined, in the example shown, by a known pressure transducer 22 inserted inside conduit 16, downstream from respective valve 18; and the pressure in each conduit 17 is monitored by a respective measuring device defined, in the example shown, by a known pressure transducer 23 inserted inside conduit 17, downstream from respective valve 19.

In connection with the above, it should be pointed out that each conduit 17 is connected to relative conduit 16, downstream from relative transducer 22.

In actual use, each unit 5 is fed through input station 6 in time with a respective bottle 2, so respective grip-and-carry device 9 receives bottle 2 with its concavity facing upwards.

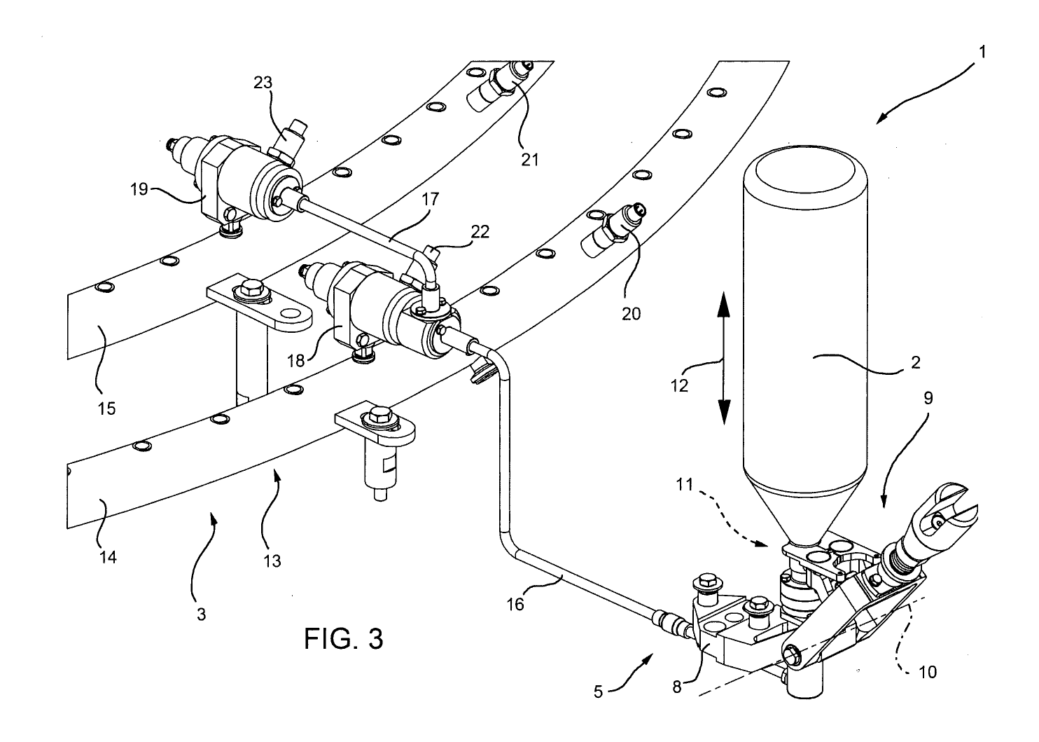

As unit 5 travels from input station 6 to output station 7, device 9 is rotated about axis 10 to turn bottle 2 upside down (FIGS. 1 and 3) over and substantially coaxially with relative nozzle 11; nozzle 11 is moved in direction 12 from a lowered rest position, in which nozzle 11 is substantially outside bottle 2, to a raised work position, in which nozzle 11 projects inside bottle 2 to rinse bottle 2; once bottle 2 is rinsed, nozzle 11 is moved back down in direction 12 to disengage bottle 2; and device 9 is rotated about axis 10 to release bottle 2 at output station 7 once more with its concavity facing upwards.

Transducers 20, 21, 22, 23 are connected to an electronic central control unit 24, which:

compares the actual pressure measurement of each transducer 20, 21, 22, 23 with a respective threshold value;

stops machine 1 when the actual pressure measurement of at least one of transducers 20, 21, 22, 23 differs from the respective threshold value;

determines failure and/or clogging of a given conduit 16 when the actual pressure measurement of relative transducer 22 differs from the respective threshold value;

determines failure and/or clogging of a given conduit 17 when the actual pressure measurement of relative transducer 23 differs from the respective threshold value;

determines failure and/or clogging of a given nozzle 11 when the actual pressure measurement of transducer 22 fitted to relative conduit 16 differs from the respective threshold value; and

activates an ejector (not shown) mounted downstream from output station 7 to reject any improperly rinsed bottles 2, when the actual pressure measurements of transducers 22 and/or 23 of relative units 5 differ from the respective threshold values.

It should be pointed out that the above-mentioned failures may include e.g. disconnection of conduits or nozzles from the connecting elements, or breakage or rupture of one or more conduits or nozzles.

It should be also pointed out that, in embodiments not shown, transducers 20, 21, 22, 23 may be mounted and employed singly or in combinations of two or more.

Transducers 20, 21, 22, 23 connected to central control unit 24 therefore provide for checking correct operation of machine 1, for stopping machine 1 in the event of a malfunction of header 14 and/or header 15 and/or one of rinsing units 5, for checking correct operation of each unit 5, and for rejecting any improperly rinsed bottles 2.

1) A rinsing machine for containers, in particular bottles, the machine comprising:
a wash wheel mounted to rotate about a given longitudinal axis and having a number of rinsing units, which are configured to be fed by the wash wheel about said axis, are each configured to receive and retain a respective container, and configured to rinse the respective containers with a wash mixture comprising a gaseous fluid and a liquid fluid;
a feed device for feeding the wash mixture to the rinsing units, the feed device comprising a first header containing the liquid fluid, a second header containing the gaseous fluid, and, for each rinsing unit, a respective first conduit for feeding the liquid fluid from the first header to the rinsing unit, and a respective second conduit for feeding the gaseous fluid from the second header to the first conduit; and
at least one of a first measuring device configured to measure the pressure in the first header and a second measuring device configured to measure the pressure in the second header.

2) A rinsing machine as claimed in claim 1, and also comprising, for each rinsing unit, at least one of a third measuring device configured to measure the pressure in the relative first conduit, and a fourth measuring device configured to measure the pressure in the relative second conduit.

3) A rinsing machine as claimed in claim 1, and also comprising an electronic central control unit configured to stop the rinsing machine when at least one of the actual pressure measurements of said measuring devices differs from a respective threshold value.

4) A rinsing machine as claimed in claim 2, and also comprising an electronic central control unit configured to compare the actual pressure measurements of at least one of the third and fourth measuring device of each rinsing unit with respective threshold values, and is connected to an ejector configured to reject the relative container when at least one of said actual pressure measurements differs from the respective threshold value.

5) A rinsing machine as claimed in claim 1, wherein each first conduit has a respective first on/off valve configured to selectively open the first conduit, and each second conduit has a respective second on/off valve configured to selectively open the second conduit.

6) A rinsing machine as claimed in claim 5, and also comprising, for each rinsing unit, a third and a fourth measuring device configured to measure the pressure in the relative said first and second conduit respectively; said third and said fourth measuring device being mounted downstream from the relative said first and said second on/off valve respectively.

7) A rinsing machine as claimed in claim 5, wherein each second conduit is connected to the relative first conduit, downstream from the relative first on/off valve.

8) A rinsing machine as claimed in claim 1, wherein each rinsing unit has a spray nozzle connected to the relative first conduit and movable between a rest position, in which the spray nozzle is substantially outside the relative container, and a work position, in which the spray nozzle extends inside the relative container.

9) A rinsing machine for containers, in particular bottles, the machine comprising:
a wash wheel mounted to rotate about a given longitudinal axis and having a number of rinsing units, which are fed by the wash wheel about said axis, are each designed to receive and retain a respective container, and rinse the respective containers with a wash mixture comprising a gaseous fluid and a liquid fluid;
a feed device for feeding the wash mixture to the rinsing units, the feed device comprising:
a first header containing the liquid fluid,
a second header containing the gaseous fluid, and,
for each rinsing unit,
a respective first conduit for feeding the liquid fluid from the first header to the rinsing unit,
a respective second conduit for feeding the gaseous fluid from the second header to the first conduit, and
at least one of a first measuring device for measuring the pressure in the relative first conduit, and a second measuring device for measuring the pressure in the relative second conduit.

10) A rinsing machine as claimed in claim 9, and also comprising a third measuring device configured to measure the pressure in the first header, and a fourth measuring device configured to measure the pressure in the second header.

11) A rinsing machine as claimed in claim 9, and also comprising an electronic central control unit configured to stop the rinsing machine when at least one of the actual pressure measurements of said measuring devices differs from a respective threshold value.

12) A rinsing machine as claimed in claim 9, and also comprising an electronic central control unit configured to compare the actual pressure measurements of at least one of the first and the second measuring device of each rinsing unit with respective threshold values, and is connected to an ejector configured to reject the relative container when at least one of said actual pressure measurements differs from the respective threshold value.

13) A rinsing machine as claimed in claim 9, wherein each first conduit has a respective first on/off valve configured to selectively open the first conduit, and each second conduit has a respective second on/off valve (19) configured to selectively open the second conduit.

14) A rinsing machine as claimed in claim 13, wherein each said first and said second measuring device are mounted downstream from the relative said first and said second on/off valve respectively.

15) A rinsing machine as claimed in claim 13 wherein each second conduit is connected to the relative first conduit, downstream from the relative first on/off valve.

16) A rinsing machine as claimed in claim 9, wherein each rinsing unit has a spray nozzle connected to the relative first conduit and movable between a rest position, in which the spray nozzle is substantially outside the relative container, and a work position, in which the spray nozzle extends inside the relative container.
